(19) United States
(12) Patent Application Publication
(10) Pub. No.: US 2004/0263800 A1
(43) Pub. Date: Dec. 30, 2004

(54) Projector replaceable part with non-conventional operational recorder

(76) Inventor: Winthrop D. Childers, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/603,396

(22) Filed: Jun. 24, 2003

(51) Int. Cl. G03B 21/20

(52) U.S. Cl. 353/85

(57) ABSTRACT

Systems and methods for recording data in a replaceable component of a digital image projector are described. A replaceable component configured to be used in an image projection system includes a non-volatile electronic memory configured to store information not directly related to conventional operation of image projection systems.

### TECHNICAL FIELD

The present disclosure relates to a replaceable component including a memory device for use in a projection system having at least one replaceable component.

### BACKGROUND

Recently, digital projection systems such as those employing spatial light modulators formed using liquid crystal displays or deformable mirror devices have gained relatively widespread use for providing images viewable by relatively large audiences. These projection systems employ relatively bright light sources that typically rely on an arc lamp bulb such as a high pressure mercury arc lamp. Such lamps typically rely on a relatively high initial voltage to strike the arc and establish suitable temperatures for maintaining a plasma followed by a lower voltage for operation of the lamp. The nature of the discharge within the arc lamp bulb coupled with a history of thermal cycling results in degradation of the bulb over time, ultimately resulting in bulb failure.

Accordingly, the arc lamp bulb is designed to be readily user-replaceable when the bulb fails. The replaceable projector component is typically sold through one of a number of sales channels. Each sales channel typically includes one or more distributors and a reseller or service provider. Each reseller or service provider typically offers a variety of replaceable projector components manufactured or distributed under different brands. Because of limited shelf space, these resellers or service providers typically offer or carry fewer brands than those from which they have to choose.

It is important that the manufacturers of each brand provide some incentive for the reseller or service provider to stock or carry its brand in order to ensure sales of that brand. Manufacturers that provide less incentive to the reseller for stocking their brands may be overlooked, resulting in lost sales.

Additionally, some disincentive for preferred resellers results when replaceable components stocks are “dumped” on the “gray” market. This may happen, for example, when a reseller overstocks replaceable components in order to get the benefit of sales volume and sells a portion of the overstocked supplies at a price that undercuts other resellers.

There is an ever-present need for techniques to build brand loyalty with the resellers or service providers. These techniques should provide an incentive for the reseller to carry a particular brand over other brands.

Additionally, in designing these relatively new types of projector systems and providing projector capabilities, it is helpful to incorporate knowledge of how projector systems are used by different types of users in varying settings. However, it can be difficult to combine some types of data in a meaningful way. For example, when surveys are conducted, user responses may vary even when there have been no significant differences in how the projection systems were employed or in how effectively the projection systems performed. The user who responds may not have knowledge of relevant usage factors—for example, when the projection system operates in a large institutional setting or at a conference.

Accordingly, there are needs for apparatus and techniques for tracking marketing/distribution trends for replaceable components in projection systems and for collecting usage information from users of such systems.

### SUMMARY

Systems and methods for recording data in a replaceable component of a digital image projector are described. In one aspect, a replaceable component configured to be used in an image projection system includes a non-volatile electronic memory configured to store information not directly related to conventional operation of image projection systems.

### BRIEF DESCRIPTION OF THE DRAWINGS

FIG. 1 is a schematic diagram of an exemplary projector system configured to project light from a light engine onto a viewing surface.

FIG. 2 is a flowchart of an exemplary process for obtaining information relative to the replaceable component.

FIG. 3 is a flowchart of an exemplary process 300 for retrieving data identifying a vendor such as a reseller for the replaceable component stored in the memory device.

### DETAILED DESCRIPTION

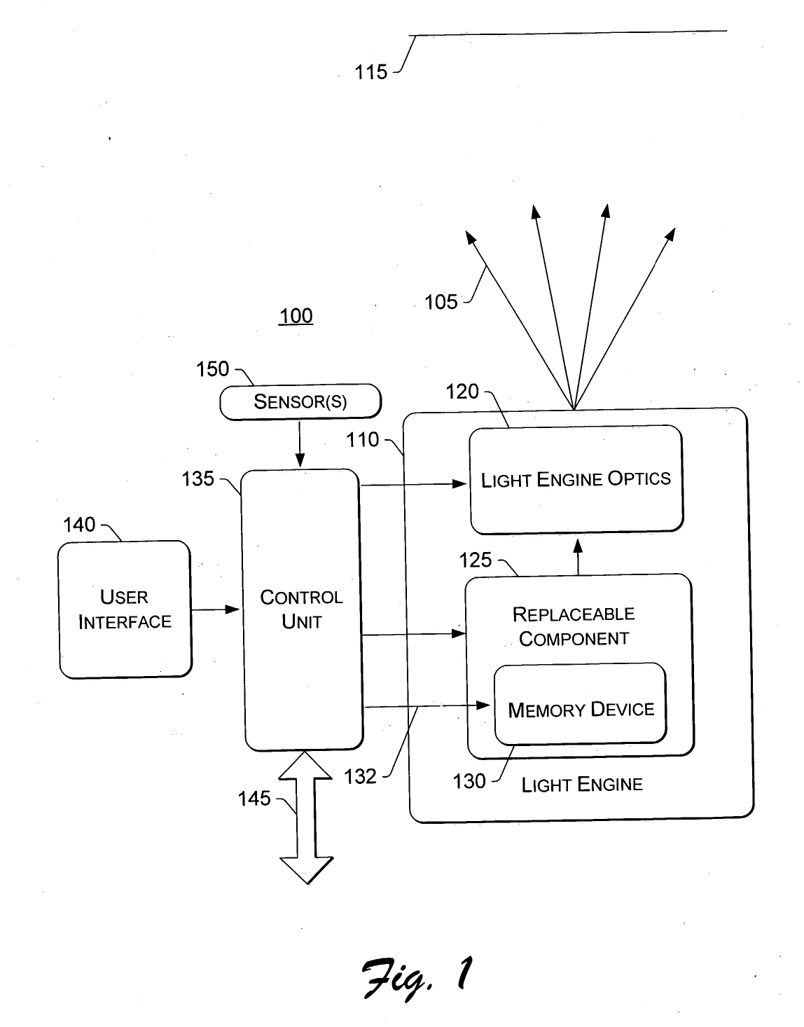

FIG. 1 shows an exemplary suitable projector environment 100 within which systems, apparatuses and methods to display images derived from a variety of different possible data sources and data types may be implemented. Exemplary projector environment 100 is only one example of a suitable projector environment and is not intended to suggest any limitation as to the scope of use or functionality of the systems and methods described herein.

The disclosed concepts are described generally as computer-executable instructions, such as a program or series of instructions that is executable by a device including one or more processors, such as a computer. The device may be a standalone device, or may be part of a distributed computing environment. Portions of a distributed computing environment may be linked via a LAN, a WAN, PSTN (POTS) or DSL, cable modems and systems, the Internet, cellular networks, infra red, alone or in any combination, or other communications media, and computer-executable code and/or data may be communicated as signals embodied in a carrier wave, all of which are embraced by the terms “computer intelligible media” or “computer readable media”, as used herein. Programs or portions thereof may include executable instructions, data and related computer-intelligible constructs intended to facilitate accomplishment of specific tasks and/or to manipulate various data, and portions may be located in local or non-local memory devices.

Computers and other electronic devices continue to develop to support increasing connectivity and data exchange modalities for sharing computer intelligible media. Computer intelligible media may include any such storage and/or exchange modality, such as portable or fixed-deployment memory devices or other data exchange protocols. Portable or fixed-deployment memory devices include RAM, ROM, WORM, EEROM, EAROM, flash memory, magnetic technology storage devices (e.g., tapes, floppy discs, hard drives), semiconductor-based memories, magneto-optic or magneto-resistive memory devices, optical storage media, DVDs, compact discs and the like, or any other media employable for computer or electronic storage and retrieval or communication of information.

FIG. 1 is an exemplary schematic diagram of a projector system 100 configured to project light 105 from a light engine 110 onto a viewing surface 115. The light engine 110 includes optics 120, a replaceable component 125 such as a high intensity light source, which may be an arc lamp, a memory device 130, a link 132 to the memory device 130, a controller 135, a user interface 140, one or more input/output ports 145 and may include one or more sensors 150.

In one embodiment, the memory device 130 is physically associated with the replaceable component 125. In one embodiment, the memory device 130 is physically associated with the replaceable component 125 such that the memory device 130 is not readily removable from the replaceable component 125. In one embodiment, the memory device 130 comprises a memory integrated circuit 130 that is physically coupled or attached to the replaceable component 125.

The optics 120 are configured to modulate light from the replaceable component 125 in response to electronic signals from the controller 135. The controller 135 may also facilitate capabilities such as image focus, compensation for “keystoning” (where the image is projected at an angle with respect to the viewing surface that would, without compensation, result in width or height aberrations along an axis of the image) and other adjustment capabilities for providing image clarity.

Signals corresponding to image data are supplied via the input/output port or ports 145 and may comprise still images (such as digital photographs), live video (such as from a video camera), analog image data (such as conventional television signals), digital image signals from any of a variety of sources (the Internet, a computer etc.). These varied signal sources can require some user adjustment via the user interface 140, and this may cause confusion. For example, when the projector system 100 is employed at a conference to render images from a series of presenters, the nature of the input signals will vary and the users who are attempting to provide the input signals and speak about the image subject matter may not be familiar with the projector system 100. These users may also have varying language skills that render instructions or options presented by the user interface 140 more or less comprehensible.

Additionally, the effectiveness of the projector system 100 may vary with factors relevant to the environment in which it is employed. For example, ambient illumination conditions will vary from one setting to another. The nature of the viewing surface 115 affects luminance of the projected image and also viewer perception of color gamut. Different types of subject matter also influence the effectiveness of the projector system. For example, color gamut or RGB capability or range usually is not usually as significant in presentation of pie charts, bulleted lists and the like, as color gamut is in viewing of movies or photographs. Data regarding ambient illumination may be collected by sensors 150 such as photodetectors incorporated into the one or more sensors 150 and may be written to the memory device 130 associated with the replaceable component 125 via the link 132.

The memory device 130 may be configured to record information reflective of user interactions with the projector system 100. For example, the memory device 130 may record keystrokes or tactile input from the user via the user interface 140 or other user input (e.g., signals coupled from a processor via the link 145) as a function of time to record which aspects of the projector system 100 are employed most often. Later analysis of such information can help in understanding which pre-programmed features of the system 100 find user acceptance and to help to determine those aspects of the system 100 that are confusing. For example, repeated efforts to adjust some aspect of the projector system 100 operation can help to determine those aspects of the system 100 or the user interface 140 that are not readily comprehensible. When such information is coupled to knowledge of a particular market venue or reseller for the replaceable component, the analysis provides knowledge of user categories and their affiliations with the marketing venue.

The memory device 130 may be configured to accept data via the link 132 and store the data over the useful life of the replaceable component 125. In one embodiment, the memory device 130 includes one or more of electrically alterable memory, memory that can be written once and read many times, memory employing fuses and/or antifuses and non-volatile memory having a protection mode for preventing stored data from being overwritten. Data compression may be employed to preserve larger amounts of data with a limited memory size. In one embodiment, the replaceable component includes a non-volatile electronic memory configured to store information not directly related to conventional operation of image projection systems.

Typically, the link 132 to the memory device 130 includes four terminals. For example, the memory device 130 may include two power terminals, a data input/output terminal and a clock input terminal. Alternatively, the memory device 130 can have other configurations such as a two terminal device. One such two terminal memory device 130 includes power and ground terminals. Clock signals and data signals are provided on the power terminal. An example of such a two terminal memory device 130 is a 1 kilobit read/write Electrically Programmable Read Only Memory (EPROM) such as the Dallas Semiconductor part number DS 1982, manufactured by the Dallas Semiconductor Corporation. The link 132 may include a radio frequency data link for data input/output functions for the memory device 130.

When the replaceable component 125 is collected and the data stored in the memory device 130 are analyzed and correlated with data from an ensemble of such replaceable components, information regarding how the systems were used or malfunctioned may be obtained and employed to guide system designers and to determine user-desirable features. The usage information may be correlated with specific marketing channels in order to tailor specific marketing channels to their respective buyer's needs. The relative frequency of display of different types of images may be determined, and the kinds of signals or software packages used to supply the images may be determined.

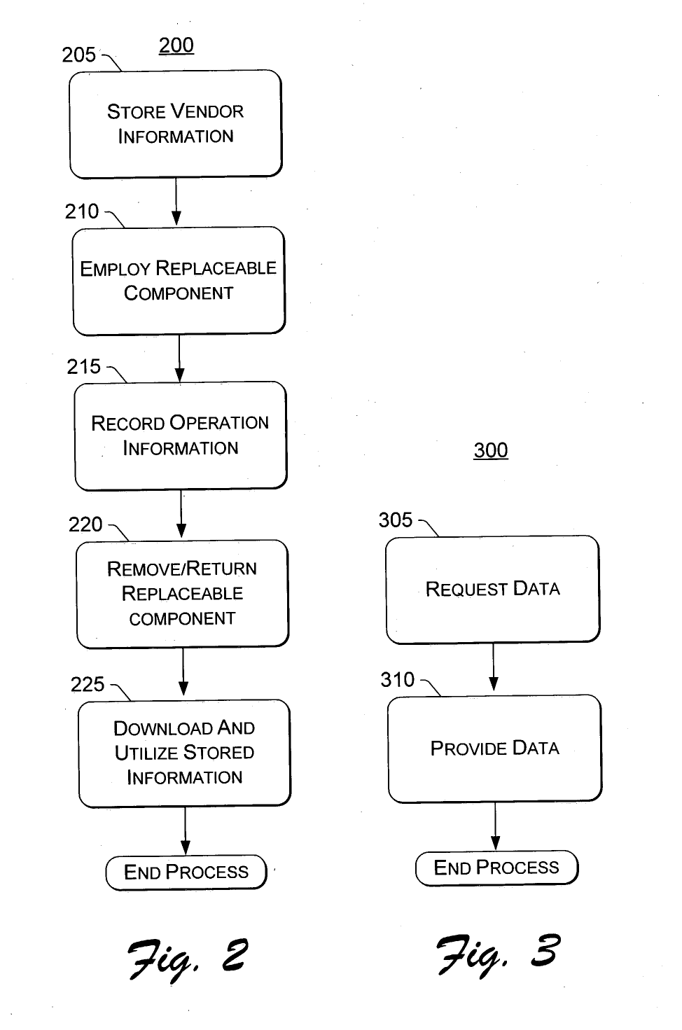

FIG. 2 is a flowchart of a process 200 for obtaining information relative to the replaceable component 125. The process 200 begins in a block 205.

In block 205, data not directly related to conventional operation of image projection systems, such as data relative to a sales channel for the replaceable component 125, are stored in the memory device 130. In one embodiment, data may be programmed into the memory device 130 by a manufacturer of the replaceable component 125 prior to shipment of the replaceable component 125. In one embodiment, data are programmed into the memory device 130 by a reseller of the replaceable component. In one embodiment, data recorded by the manufacturer or reseller are recorded in a portion of the memory device 130 having write-once, read many times functionality to avoid such data being over-written at a later time. In one embodiment, a write-protectable portion of the memory device 130 is written with such data and then is write protected by either a manufacturer or a reseller of the replaceable component 125 prior to delivery to an end user of the replaceable component.

An end user subsequently employs the replaceable component 125 in a block 210. The user may obtain the replaceable component by obtaining the projection system 100 with the replaceable component 125 installed or may purchase and install the replaceable component 125.

In a block 215, data not directly related to conventional operation of image projection systems, including operation and/or usage information, is recorded in the memory device 130 during operation of the projection system. In other words, a projector replaceable part includes a non-conventional operations data recorder. The usage information or operations log may include frequency of operation of the projection system 100 (e.g., dates and times of operation) and/or frequency and duration of operation of the replaceable component 125 (e.g., identifying gaps where the projection system is in “sleep mode” such that the replaceable component 125 is not powered but the projection system 100 is powered). The usage information may describe the types of signals supplied to the projection system (e.g., analog, digital, video, still, color content, spatial frequency of content). The usage information may include data regarding ambient conditions during operation of the projection system (intensity and color gamut of ambient illumination), focal distance and other projection system set up information.

The projection system 100 may include a capability for onboard operation of software as well as a capability for display of images produced by operation of such software. For example, the projection system 100 may be compatible with operation of software such as presentation preparation software packages (e.g., Powerpoint, available from the Microsoft Corporation of Redmond, Wash.), document retrieval software, word processing programs, spreadsheet programs, computer aided design tools, web browsers, graphics packages, digital photograph display/manipulation software or other software configured to manipulate specific data file types. The memory device 130 may be configured to record information identifying the relevant software package and frequency of operation of such software to provide image data.

The projection system 100 may also include capability to interface with or may incorporate various types of playback devices such as digital versatile disc players and the like. The memory device 100 may include a capability for recording the type of media and player employed to provide input signals.

The operation information also may include hardware or software failure codes. These may represent such events as software crashes and projection system malfunction information. Software crashes may be indicative of combinations of software, hardware and uses of projection systems 100 that were not expected by designers of the projection system 100. Such information may be employed in designing software or hardware updates, in debugging system errors or in designing projection systems 100 to be more robust for certain applications or uses.

The operation information may also include information having marketing and maintenance implications. Such may include information indicative that a user had difficulty setting the projection system 100 up—as distinguished from when the projection system 100 operated for a period of time without user adjustment. The information may include a time/date stamp for when the projection system 100 was turned on, keypad or other tactile input actuations, accessing of setup software, and the like.

In a block 220, the replaceable component 125 is removed and replaced. In one embodiment, the replaceable component 125 may be returned to the manufacturer. One vehicle for encouraging such return employs a pre-addressed return container coupled with a rebate or other consumer benefit triggered by return of the removed replaceable component 125. One vehicle is to provide analogous incentives via resellers of the replaceable component 125.

In a block 225, data are extracted from the memory device 130 and are collected into a database. In one embodiment, the data may be extracted by coupling the memory device 130 to a reader at the manufacturer following return of the replaceable component 125. In one embodiment, the control unit 135 includes capability for transmitting the information to the manufacturer, for example via the data port 145 and the Internet. Such may be triggered by failure of the replaceable component 125 or by passage of a predetermined interval or achievement of a predetermined number of hours of operation of the replaceable component 125 and/or system 100. The process 200 then ends.

FIG. 3 is a flowchart of a process 300 for retrieving data identifying a vendor such as a reseller for the replaceable component 125 stored in the memory device 130. Such information may be stored in a standard memory location in the memory device 130.

In a block 305, the user requests access to data stored in the memory device 130. For example, the user may request data from the memory device via the user interface 140 or using an external device coupled via the port 145.

In a block 310, information intended to facilitate ordering of a replacement for the replaceable component 125 is provided. The information may be accessible via any of the images formed by the projection system (prior to failure of the replaceable component 125 when such is the only illumination source for the projection system) or the user interface. When the projection system 100 includes a capability for directly accessing a public information channel such as the Internet, the information may facilitate contacting the vendor via the Internet to supply information relative to the replaceable component 125. For example, the information may include a universal resource locator (URL) facilitating web browser access to a market channel or a reseller. Information may be transmitted to a manufacturer or reseller via the Internet and may include customer identification indicia provided by either the system 100, the user or information stored in the memory device 130 when sold to the user.

The data may be any type of data so that the customer can properly reorder from the same reseller and may include a universal resource locator or URL, telephone contact information, physical address information, an email address or the like for identifying a relevant portion of a sales channel for distribution of the replaceable component 125. Typically, there are numerous different sales channels available to the manufacturer for selling products to the customer.

The data typically identifies a manufacturer who manufacturers the replaceable component 125. Often, the manufacturer sells the replaceable component 125 to an intermediate channel (e.g., one or more distributors) which then sell the replaceable component 125 to a reseller or service provider, or the manufacturer may sell the replaceable component 125 to the reseller or to the end user. The vendor, which may be the reseller or service provider, sells the replaceable component 125 to a customer. Either the customer or a service provider installs the replaceable component 125 into the projection system 100.

At reorder time, the customer retrieves the vendor identification and component identification information from the replaceable component 125 so that the reseller can be identified for reordering the replaceable component 125. For example, the information may include a part number for the replaceable component 125.

The component identification information is used to aid the customer in identifying the particular model of the replaceable component 125 to ensure that the proper replaceable component 125 is reordered. There are numerous other arrangements in which the reseller information stored in the replaceable component 125 can be utilized to order a replacement for the replaceable component.

One such arrangement is where the replaceable component 125 is returned to the manufacturer who then retrieves the reseller information from the replaceable component 125. The manufacturer either sends a replaceable component 125 to the customer or contacts the reseller to send a new replaceable component 125 to the customer. In another arrangement, the manufacturer is identified from the information stored in the replaceable component 125. The customer contacts the manufacturer who assists or selects a reseller for the customer. Once a replacement for the replaceable component 125 has been ordered, the process 300 ends.

### Conclusion

The described systems and methods enhance image processing with shared data storage. Although the systems and methods have been described in language specific to structural features and methodological operations, the subject matter as defined in the appended claims are not necessarily limited to the specific features or operations described. For example, although the exemplary system 100 of FIG. 1 has been described with respect to projection systems, the described systems and techniques can also be applied to other types of electronic products, where one or more elements has a limited useful life and will normally be replaced by the end user several times. Thus, the specific features and operations are disclosed as exemplary forms of implementing the claimed subject matter.

1. A replaceable component configured to be used in an image projection system, the replaceable component including a non-volatile electronic memory configured to store information not directly related to conventional operation of image projection systems.

2. The replaceable component of claim 1, wherein the non-volatile electronic memory is configured to store information identifying a source for a replacement for the replaceable component.

3. The replaceable component of claim 1, wherein the non-volatile electronic memory is configured to provide ordering information including a part number and a vendor for the replaceable component.

4. The replaceable component of claim 1, wherein the non-volatile electronic memory is configured to identify a reseller through whom the replaceable component was sold.

5. The replaceable component of claim 1, wherein at least a portion of the non-volatile electronic memory is configured to be write protected following data storage.

5. The replaceable component of claim 1, wherein the replaceable component comprises an illumination source for the image projection system, and wherein the non-volatile electronic memory comprises a memory integrated circuit that is physically coupled to the non-volatile electronic memory.

6. The replaceable component of claim 1, wherein the non-volatile electronic memory is configured to store an operations log for the image projection system.

7. The replaceable component of claim 1, wherein the replaceable component comprises an arc lamp bulb.

8. The replaceable component of claim 1, wherein the replaceable component comprises an arc lamp bulb and the non-volatile electronic memory comprises a memory integrated circuit that is physically coupled to the replaceable component.

9. The replaceable component of claim 1, wherein the non-volatile electronic memory includes an electrically alterable memory having a first write-protectable portion configured to provide the information identifying a source of the replaceable component and a second writeable portion configured to store data during operation of the image projection system.

10. A projection system comprising:
a light engine configured to employ a replaceable component including an electronic memory device;
a controller coupled to the light engine;
a linking portion coupled to the control portion and configured for transferring information between the replaceable component and the projector system; and
a user interface coupled to the controller and configured to accept user input for configuring the display device, the controller being configured to store data in and/or retrieve data from the electronic memory device, the electronic memory device configured to store information not directly related to conventional operation of image projection systems.

11. The projection system of claim 10, wherein the replaceable component includes an arc lamp bulb, and wherein the electronic memory device comprises a memory integrated circuit that is physically coupled to the replaceable component.

12. The projection system of claim 10, wherein the controller is configured to write an operations log to the electronic memory device.

13. The projection system of claim 10, wherein the controller is configured to store data in the memory device describing signal sources employed to provide data corresponding to an image to be displayed by the projection system.

14. The projection system of claim 10, wherein the electronic memory device comprises an electrically alterable memory having a first write-protectable portion configured to provide the information identifying a source for the replaceable components and a second writeable portion configured to store an operations log during operation of the image projection system.

15. The projection system of claim 10, wherein the replaceable component comprises an illumination source for the projection system, and wherein the electronic memory device comprises a memory integrated circuit physically coupled to the illumination source.

16. The projection system of claim 10, wherein the linking portion comprises only two electrical connections.

17. The projection system of claim 10, wherein the linking portion comprises an RF link.

18. The projection system of claim 10, wherein the projection system includes sensors configured to assess operating conditions associated with an environment in which the projection system is operated, and wherein the electronic memory device is configured to store data representing the assessed operating conditions.

19. The projection system of claim 10, wherein the projection system includes sensors configured to assess operating conditions associated with an environment in which the projection system is operated including ambient lighting conditions, and wherein the electronic memory device is configured to store data representing the assessed operating conditions.

20. The projection system of claim 10, wherein the electronic memory device is configured to provide data indicative of a sales channel for a replacement for the replaceable light source.

21. A replaceable projector component for use in an image projector system, the projector system having a control portion for controlling operation of the projector system, the replaceable component including a memory integrated circuit including a first write-protectable portion configured to store information prior to installation of the replaceable component in the projector system and to write protect the information after installation of the replaceable component in the projector system and a second writeable portion configured to store data during operation of the projector system.

22. The replaceable projector component of claim 21, wherein the memory integrated circuit is configured to provide at least a portion of the information identifying a reseller of replacements for the replaceable projector component.

23. The replaceable projector component of claim 21, wherein the memory integrated circuit is configured to provide at least a portion of the information identifying a part number for the replaceable component.

24. The replaceable projector component of claim 21, wherein the replaceable projector component includes an illumination source for the projector system.

25. The replaceable projector component of claim 21, wherein the replaceable projector component includes an illumination source for the projector system and the memory integrated circuit is physically attached to the illumination source.

26. The replaceable projector component of claim 21, wherein the replaceable projector component includes a high intensity light source and the memory integrated circuit is physically coupled to the high intensity light source.

27. The replaceable projector component of claim 21, wherein the replaceable projector component includes an arc lamp bulb and the memory integrated circuit is attached to the arc lamp bulb.

28. The replaceable projector component of claim 21, wherein the projector system includes one or more sensors configured to measure aspects of an environment in which the projector system operates and wherein the control portion is configured to write data corresponding to sensor output data in the memory integrated circuit.

29. The replaceable projector component of claim 21, wherein the projector system includes one or more sensors configured to measure aspects of an environment in which the projector system operates including ambient lighting conditions and wherein the control portion is configured to write data corresponding to sensor output data in the memory integrated circuit.

30. A method of forming a replaceable component for a digital image projection system comprising physically attaching an electronic memory device to the replaceable component, wherein the replaceable component comprises a high intensity illumination source, and wherein the electronic memory device is a non-volatile memory configured to store data during operation of the digital image projection system.

31. The method of claim 30, further comprising writing information to a write-protectable portion of the electronic memory device.

32. The method of claim 30, further comprising writing information to a write-protectable portion of the electronic memory device and then write protecting the write-protectable portion.

33. The method of claim 30, further comprising writing information to a write-protectable portion of the electronic memory device, the information corresponding to a part number for the replaceable component and corresponding to a vendor that sells replaceable components configured to replace the replaceable component.

34. The method of claim 30, wherein physically attaching comprises physically attaching a memory integrated circuit comprising the electronic memory device to an arc lamp comprising the high intensity light source.

35. A method for recording information in a non-volatile memory device associated with a replaceable component for a digital image projection system comprising:
coupling a processor to the memory device;
writing the information to the memory device;
decoupling the processor from the memory device; and
shipping the replaceable component to a user of the replaceable component.

36. The method of claim 35, wherein writing information to the memory device comprises writing information permitting identification of a reseller of replacements for the replaceable component.

37. The method of claim 35, wherein writing information comprises writing information permitting identification of a vendor of the replaceable component.

38. The method of claim 35, wherein writing information comprises writing information configured to facilitate ordering a replacement for the replaceable component.

39. The method of claim 35, wherein writing information comprises writing information describing the replaceable component in a write-protectable portion of the memory device and then write-protecting the portion.

40. The method of claim 35, wherein writing information comprises writing information permitting identification of a vendor of the replaceable component in a write-protectable portion of the memory device and then write-protecting the portion.

41. A digital image projection system comprising:
replaceable component means useful in the projection system and including memory means;
exchange means for exchanging data with the memory means;
means for spatial light modulation;
illumination means for illuminating the spatial light modulation means;
signal means for providing signals corresponding to images to be displayed to the means for spatial light modulation, the signal means being coupled to the means for spatial light modulation;
control means coupled to the signal means, the means for spatial modulation and the exchange means, the control means being configured to:
co-ordinate operation of the means for spatial light modulation and the signal means to facilitate conventional projector operation; and
store information not directly related to conventional operation of image projection systems in the memory means via the exchange means.

42. The system of claim 41, wherein the replaceable component means comprises the illumination means and includes a high intensity illumination source coupled with a memory integrated circuit.

43. The system of claim 41, wherein the replaceable component means comprises the illumination means and includes an assemblage of an arc lamp bulb and a memory integrated circuit.

44. The system of claim 41, wherein the replaceable component means comprises the illumination means and includes a high intensity illumination source and a memory integrated circuit having a write-protectable portion.
